(19) United States
(12) Patent Application Publication
(10) Pub. No.: US 2008/0096035 A1
(43) Pub. Date: Apr. 24, 2008

(54) Thermo-Coating

(76) Inventor: Ronald David Jones, Auckland (NZ)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/577,709

(22) PCT Filed: Oct. 21, 2005
(86) PCT No.: PCT/NZ05/00277

§ 371 Date: Sep. 12, 2007

(30) Foreign Application Priority Data
Oct. 22, 2004 (NZ) 536137

(51) Int. Cl. B32B 27/32; C08K 3/10; C08K 3/32; C08K 5/04

(52) U.S. Cl. 428/523; 524/394; 524/396; 524/416; 524/437; 524/502; 525/185

(57) ABSTRACT

A thermo-coating formed from a polyolefin and a hydrocarbon resin providing a layer substantially impervious to aqueous liquids, and a method of manufacturing.

### TECHNICAL FIELD OF THE INVENTION

The invention broadly relates to a thermo-coating to reduce aqueous liquid penetration through a surface coating (such as a floor or wall covering), and will be described herein with reference to this application. However, it will be appreciated that the invention may have other applications where a surface is required to be substantially impervious to aqueous liquid. The invention also relates to a surface coating including the thermo-coating and to a composition and method for forming the thermo-coating.

Throughout the specification, reference is made to a “substrate”. A substrate is intended to refer to a base onto which surface coating is laid or bonded, and is typically a solid and substantially flat surface. A substrate may typically include a floor or wall system formed from a plurality of floor or wall boards, a concrete floor or wall, a plasterboard system, a paving, a surface of bricks or tiles, or the like. The substrate may also include the frame for a staircase and other like structures.

### BACKGROUND TO THE INVENTION

Tufted, woven and needle punch carpets and other surface coatings are used extensively in commercial and domestic applications. Carpets have been developed for indoor and outdoor use.

However, the use of carpets in many industrial, laboratory and medical settings has been limited principally through inherent problems with the structure of carpet. Carpets and rugs cannot easily be used in hospitals, laboratories or surgical environments because fluids including body fluids (eg blood and urine), and other aqueous fluids, can soak through the upper wool or synthetic layers of carpet and may spread across the underlying substrate.

It will be appreciated that in a medical situation, it is highly undesirable for liquids including body fluids to become trapped in or beneath carpet. For this reason, carpets are generally avoided in hospital, medical, laboratory and industrial situations. In fact, recent industry standards, particularly in Europe, mean that carpets of conventional manufacture are prohibited in medical or laboratory areas due to the health risks they inherently possess.

Moisture trapped within and beneath carpets can also cause deterioration of the carpet, underlay and substrate, and can encourage bacterial and fungal build-up. A build-up of moisture between the carpet and substrate can result in decay of the substrate eventually leading to overall structural instability of the floor. Moisture can transport bacteria and fungi deep into the carpet as well as supply nutrients to inhabiting fungi and bacteria. Carpet can rapidly become unhealthy, smell and rot through bacterial activities.

Currently, processes such as steam cleaning are used in an attempt to clean carpets and withdraw liquids which may be beneath carpets. However, steam cleaning typically applies a slight pressure of about 5 psi at about 110° C. to the carpet which can end up driving moisture through carpet towards the underlying substrate.

In addition, for steam cleaning to be effective, carpets are required to be thoroughly dried out following cleaning otherwise moisture content in the carpet can be further increased by the steam cleaning process. Carpets can remain damp, which allows continued deterioration of the carpet, underlay and/or substrate.

The difficulties associated with the use of carpets mean that most industries are left with no alternative but to use vinyl, sealants, urethanes or self-levelling compounds to provide surface coatings.

Vinyl floor coatings have a number of difficulties associated with their use. While vinyl is a cost-competitive product and, if laid in seamless form, is substantially impermeable to aqueous liquids, in use vinyl is slippery and potentially hazardous when wet. In addition, as vinyl ages, phthalates or plasticizers, leach from the vinyl to become visible on the surface, creating stains on anything that it comes into contact with. Vinyl is also difficult to dispose of due to the fact it is non-recyclable.

Urethane flooring systems and self-levelling compounds have been used extensively in high density traffic areas such as train or bus stations, supermarkets and malls. Urethane and self-levelling compounds may be substantially impervious to aqueous liquids when first applied to a substrate. However, significant preparation of the substrate is required. The substrate must provide a perfect bonding surface for the urethane or compound, in order to achieve an impervious finish. In addition, urethanes and self-levelling compounds can crack or split if the ground moves even slightly, which allows liquid to drain through the surface and penetrate the substrate beneath.

Efforts to develop carpets substantially impervious to aqueous liquids have been only partially successful. Small rugs have been developed which include a PVC backing contiguous with the carpet material. PVC is the main ingredient in vinyl floorings. These rugs have been used in wet areas such as bathrooms and kitchens.

Rugs which have a backing of PVC have a number of disadvantages. PVC, over time, has a high propensity towards cracking and splitting, and has low performance characteristics when applied to fabric, i.e. wool or polyester. This is because PVC and PVC derived products have low fibre adherence capabilities.

There are health issues in using PVC in manufacturing processes. The fumes of burning PVC are highly toxic.

PVC is not recyclable, and very difficult to dispose of, as burying the product releases plasticizers, which are highly contaminant, and burning the product releases cyanide and chlorine gases.

The problems associated with PVC backed carpets have led to a general view within the flooring industry that manufacturing carpets backed with an impervious material is impracticable, time consuming and cannot meet environmental and Health and Safety regulations without major cost to the manufacturer.

### OBJECT OF THE INVENTION

It is an object of the invention to provide a thermo-coating, surface coating or composition which overcomes or ameliorates at least one of the above-mentioned disadvantages and/or to at least provide the public with a useful choice.

### SUMMARY OF THE INVENTION

According to one aspect of this invention there is provided a thermo-coating formed from:
a polyolefin and
a hydrocarbon resin.

Preferably, said polyolefin is an amorphous polyolefin of low molecular weight with a high softening point.

Preferably, the amorphous polyolefin of low molecular weight is a poly-α-olefin.

Preferably, the hydrocarbon resin is selected from cycloaliphatic hydrocarbon resins, polyterpene resins, AMS phenolic resins and/or toloil resin.

Preferably, the thermo-coating is formed from:
an amorphous poly-α-olefin;
a hydrocarbon resin;
an ignition resistant component; and
an anti-oxidant component.

Preferably, the thermo-coating includes an inorganic/organic extender.

Preferably, the ignition resistant component is selected from ammonium phosphate, decabromodiphenyl oxide and/or alumina trihydrate.

Preferably, the anti-oxidant component is pentaerythritol.

Preferably, the thermo-coating is formed from:
50 to less than 100% (w/w) of amorphous poly-α-olefin;
to 50% (w/w) of hydrocarbon resin;
1 to 50% (w/w) of an inorganic/organic extender;
1 to 10% (w/w) of ignition resistant component; and
0.1 to 0.5% (w/w) of anti-oxidant component.

Preferably, the thermo-coating is formed from:
less than or equal to 80% (w/w) of amorphous poly-α-olefin;
less than or equal to 20% (w/w) of cycloaliphatic hydrocarbon resin;
less than or equal to 50% (w/w) of an inorganic/organic extender;
8% (w/w) of ammonium phosphate; and
0.2% (w/w) of pentaerythritol.

Preferably, the thermo-coating has a softening point of at least 124° C.+/−6° C.

Preferably, the thermo-coating is capable of providing a layer that is substantially impervious to aqueous liquids.

Preferably, the thermo-coating is provided as a contiguous layer with a surface material.

Preferably, the surface material includes a standard carpet or any other form of floor covering.

Preferably, the thermo-coating is provided as a tape, panel, tile, layer laminate or the like.

According to a further aspect of this invention there is provided a surface coating formed from a surface material and a thermo-coating formed from:
a polyolefin; and
a hydrocarbon resin
   wherein the thermo-coating provides a layer in the surface coating substantially impervious to aqueous liquids.

Preferably, the polyolefin includes an amorphous polyolefin of low molecular weight with a high softening point.

Preferably, the amorphous polyolefin of low molecular weight is a poly-α-olefin.

Preferably, the hydrocarbon resin is selected from cycloaliphatic hydrocarbon resins, polyterpene resins, AMS phenolic resins and/or toloil resin.

Preferably, the thermo-coating is formed from:
an amorphous poly-α-olefin;
a hydrocarbon resin;
an ignition resistant component; and
an anti-oxidant component.

Preferably, the thermo-coating includes an inorganic/organic extender.

Preferably, the ignition resistant component is selected from ammonium phosphate, decabromodiphenyl oxide and/or alumina trihydrate.

Preferably, the anti-oxidant component is pentaerythritol.

Preferably, the thermo-coating is formed from:
50 to less than 100% (w/w) of amorphous poly-α-olefin;
to 50% (w/w) of hydrocarbon resin;
1 to 50% (w/w) of an inorganic/organic extender;
1 to 10% (w/w) of ignition resistant component; and
0.1 to 0.5% (w/w) of anti-oxidant component.

Preferably, the thermo-coating is formed from:
less than or equal to 80% (w/w) of amorphous poly-α-olefin;
less than or equal to 20% (w/w) of cycloaliphatic hydrocarbon resin;
less than or equal to 50% (w/w) of an inorganic/organic extender;
8% (w/w) of ammonium phosphate; and
0.2% (w/w) of pentaerythritol.

Preferably, the thermo-coating is provided as a tape, panel, tile, layer, laminate or the like.

Preferably, the thermo-coating is provided as a contiguous layer with the surface material.

Preferably, the surface material includes carpet or any other form of floor covering.

According to a further aspect of this invention, there is provided a composition for preparing a thermo-coating as described above, said composition including:
a polyolefin; and
a hydrocarbon resin.

Preferably, the polyolefin is an amorphous polyolefin of low molecular weight with a high softening point.

Preferably, the amorphous polyolefin of low molecular weight is a poly-α-olefin.

Preferably, the hydrocarbon resin may be selected from cycloaliphatic hydrocarbon resins, polyterpene resins, AMS phenolic resins and/or toloil resin.

Preferably, the composition includes:
an amorphous poly-α-olefin;
a hydrocarbon resin;
an ignition resistant component; and
an anti-oxidant component.

Preferably, the thermo-coating includes an inorganic/organic extender.

Preferably, the ignition resistant component is selected from ammonium phosphate, decabromodiphenyl oxide and/or alumina trihydrate.

Preferably, the anti-oxidant component is pentaerythritol.

Preferably, the composition includes:
50 to less than 100% (w/w) of amorphous poly-α-olefin;
to 50% (w/w) of hydrocarbon resin;
1 to 50% (w/w) of an inorganic/organic extender;
1 to 10% (w/w) of ignition resistant component; and
0.1 to 0.5% (w/w) of anti-oxidant component.

Preferably, the composition includes:
less than or equal to 80% (w/w) of amorphous poly-α-olefin;
less than or equal to 20% (w/w) of cycloaliphatic hydrocarbon resin;
less than or equal to 50% (w/w) of an inorganic/organic extender;
8% (w/w) of ammonium phosphate; and
0.2% (w/w) of pentaerythritol.

Preferably, the composition may be adapted to be applied directly to a substrate to form the thermo-coating.

According to a further aspect of this invention there is provided a surface coating substantially impervious to aqueous liquids, formed from a surface material and a thermo-coating contiguous with said surface material, said thermo-coating formed from a composition including a polyolefin and a hydrocarbon resin.

Preferably, the surface material includes carpet or the like.

Preferably, the polyolefin includes an amorphous poly-α-olefin of low molecular weight with a high softening point.

Preferably, the composition includes:
an amorphous poly-α-olefin;
a hydrocarbon resin;
an ignition resistant component; and
an anti-oxidant component.

Preferably the composition includes an inorganic/organic extender.

Preferably, the ignition resistant component is selected from ammonium phosphate, decabromodiphenyl oxide and/or alumina trihydrate.

Preferably, the anti-oxidant component is pentaerythritol.

Preferably, the hydrocarbon resin is selected from cycloaliphatic hydrocarbon resins, polyterpene resins, AMS phenolic resins and/or toloil resin.

Preferably, the composition includes:
50 to less than 100% (w/w) of amorphous poly-α-olefin;
to 50% (w/w) of hydrocarbon resin;
1 to 50% (w/w) of inorganic/organic extender;
1 to 10% (w/w) of ignition resistant component; and
0.1 to 0.5% (w/w) of anti-oxidant component.

Preferably, the composition includes:
less than or equal to 80% (w/w) of amorphous poly-α-olefin;
less than or equal to 20% (w/w) of cycloaliphatic hydrocarbon resin;
less than 50% (w/w) of inorganic/organic extender;
8% (w/w) of ammonium phosphate; and
0.2% (w/w) of pentaerythritol.

According to a further aspect of this invention there is provided a method of manufacturing a surface coating substantially impervious to aqueous liquids, including the step of applying a composition formed from a polyolefin and a hydrocarbon resin to a surface material to form the surface coating, the composition forming an aqueous liquid impervious thermo-coating following mixing the polyolefin and hydrocarbon resin, heating the mixture and applying the heated mixture to the surface material.

Preferably, the composition is applied to the surface material to form a contiguous layer with the surface material.

Preferably, the surface material includes carpet or any other form of floor covering.

According to a further aspect of this invention there is provided a kit of parts for manufacturing a composition which in use provides a thermo-coating as described above, the kit of parts including:
a polyolefin; and
a hydrocarbon resin.

According to a further aspect of the invention there is provided a thermo-coating, substantially as herein described with reference to the Figures.

According to a further aspect of the invention there is provided a surface coating substantially as herein described and with reference to the Figures.

According to a further aspect of the invention there is provided a composition substantially as herein described and with reference to the Figures.

According to a further aspect of the invention there is provided a method of manufacturing a surface coating substantially as herein described and with reference to the Figures.

According to a further aspect of this invention there is provided a kit of parts for manufacturing a composition substantially as herein described and with reference to any one of the Examples.

### BRIEF DESCRIPTION OF THE FIGURES

The present invention will now be described by way of example and with reference to the Figures, in which:

FIG. 1 shows an apparatus for use in applying the thermo-coating according to a preferred form of the invention

FIG. 2 illustrates an exploded perspective view of a surface coating of the present invention. A refers to the surface material (carpet), B refers to the thermo-coating of the present invention and C refers to an additional layer of scrim.

FIG. 3 illustrates an exploded perspective view of another surface coating of the present invention. A refers to a layer of surface material (carpet), B refers to a second layer of surface material (fibreglass) and C refers to the thermo-coating of the present invention; and

FIG. 4 illustrates an exploded perspective view of a further surface coating of the present invention. A refers to a layer of surface material (synthetic turf), B refers to a second layer of surface material (fibreglass) and C refers to the thermo-coating of the present invention.

### DESCRIPTION OF THE INVENTION

The present invention provides a thermo-coating particularly adapted in use to manufacture a surface coating such as a floor or wall covering. The invention also provides a surface coating, a composition for a thermo-coating and a method of manufacturing a surface coating including a thermo-coating.

The thermo-coating is described as “thermo” throughout the specification because the coating is adapted to soften (eg bend, melt, etc) at relatively high temperatures of preferably greater than about 110° C. This reduces the likelihood of the thermo-coating breaking down in a working environment.

The thermo-coating of the present invention is formed from a polyolefin and a hydrocarbon resin. The components are mixed, heated, and allowed to cool forming the thermo-coating.

In the preferred embodiment, the polyolefin is selected from an amorphous (or non-crystalline) polyolefin of low molecular weight with a high softening point.

A variety of amorphous polyolefins may be selected for the present invention. The flexibility and softening points of the resulting thermo-coating generally direct the selection of an appropriate polyolefin.

Flexibility is an important characteristic. A surface coating, formed by the thermo-coating joined to a surface material (eg carpet material), is presented to the public in rolled form, and may be laid on even or uneven surfaces. A roll of surface coating should have good flexibility and minimum residual memory when unrolled to cover an uneven surface, without cracking or crazing occurring.

It is also desirable that the polyolefin is structurally stable up to a temperature of at least 110° C. If the polyolefin is not stable in temperatures up to 110° C., destabilisation of the resulting thermo-coating in use may occur when placed in a working environment, (eg where sunlight hits the surface coating), or generally in areas that are exposed to temperature fluctuations. Heat magnified through windows onto carpet, or radiated from domestic or commercial heaters can heat surfaces up considerably. It is therefore desirable that the polyolefin has a relatively high softening point to reduce the possibility of breaking down through standard work place temperatures.

The ability of the thermo-coating to act as a layer substantially impervious to aqueous liquids will in part depend on the stability of the polyolefin which can, if needed, be selected to take such issues into account. Polyolefins having lower temperature stability can be acceptable in some circumstances where a surface coating will subsequently be exposed in use to lower surrounding temperatures (about a constant 10 to 20° C.).

Table 1 sets out in more detail typical properties of a preferred amorphous polyolefin which may be used in the present invention.

TABLE 1
Polyolefin properties

| Property | Unit | Typical Value |
|---|---|---|
| Melt Viscosity at 190° C. | ° C. | 2,700 ± 700 |
| Softening Point | ° C. | 124 ± 6 |
| Needle Penetration | 0.1 mm | 12 ± 3 |
| Thermal Stability under Load | ° C. | 75-80 |
| Tear Strength | % | 43 |
| Shear Modulus at 23° C. | mPa | 41 |
| Molecular Weight | g/mol | 7,300 |
| Open Time | Seconds | 15 |
| Setting Time | Seconds | 1 |
| Glass Transition Temperature | ° C. | −28 |
| Density at 23° C. | g/cm³ | 0.87 |

The inventors have found that a preferred amorphous polyolefin may include a poly-α-olefin. Typically, poly-α-olefins meet the properties of Table 1. In the preferred embodiment the polyolefin is an amorphous copolymer of the α olefins ethylene, propylene and 1-butene. The amorphous polyolefin used is ideally a high-tack, low molecular weight product with a high softening point. This ensures flexibility of the thermo-coating while having a relatively high softening point.

In the preferred embodiment, the thermo-coating includes 50 to less than 100% (w/w) of an amorphous poly-α-olefin, and more preferably less than or equal to about 80% (w/w) of the amorphous poly-α-olefin.

Amorphous polyolefins have reduced “grab” relative to polyolefins that are more crystalline in structure. Grab refers to the ability of the thermo-coating to securely bond to a surface material such as the undersurface of a carpet material. Grab is particularly important when the thermo-coating is provided and sold as part of the surface coating.

The inventors have surprisingly found that hydrocarbon resins which have a high softening point can improve the grab of the amorphous polyolefins. The hydrocarbon resin acts as a tackifier to improve the grab of the amorphous polyolefin onto the surface material.

Most hydrocarbon resins or tackifiers commonly in use, such as those used in standard hot melt formulations, have an inherent relatively low softening point of about 75° C. which could make them unsuitable to provide the thermo-coating of the present invention as the thermo-coating may become unstable in the work environment temperature and break down.

The hydrocarbon resin will therefore probably have a relatively high softening point, of equal to or greater than about 110° C.

In the preferred embodiment, the hydrocarbon resin may be selected from cycloaliphatic hydrocarbon resins, polyterpene resins, AMS phenolic resins and/or toloil resin. Tables 2 to 5 below illustrate the properties of these preferred hydrocarbon resins. Significantly they all possess relatively high softening points, meaning that a thermo-coating including any one of these hydrocarbon resins is less likely to discompose in working environment conditions or generally any area exposed to temperature fluctuations.

TABLE 2
Polyterpene Resin

| Property | Unit | Typical Value |
|---|---|---|
| Melt Viscosity 190° C. | mPa · s | 1,300 |
| Softening Point | ° C. | 135 |
| Molecular Weight | g/mol | 815 |
| Glass Transition Temperature | ° C. | 90 |

TABLE 3
AMS Phenolic Resin

| Property | Unit | Typical Value |
|---|---|---|
| Melt Viscosity 190° C. | mPa · s | 1,740 |
| Softening Point | ° C. | 140 |
| Molecular Weight | g/mol | 1,990 |
| Glass Transition Temperature | ° C. | 79 |

TABLE 4
Cycloaliphatic Hydrocarbon Resin

| Property | Unit | Typical Value |
|---|---|---|
| Melt Viscosity at 190° C. | mPa · s | 4,000 |
| Softening Point | ° C. | 138 |
| Molecular Weight | g/mol | 380 |
| Glass Transition Temperature | ° C. | 90 |

TABLE 5
Toloil Resin

| Property | Unit | Typical Value |
|---|---|---|
| Melt Viscosity at 190° C. | mPa · s | 2,000 |
| Softening Point | ° C. | 105 |
| Molecular Weight | g/mol | 980 |
| Glass Transition Temperature | ° C. | 85 |

It will be appreciated by those skilled in the art that various other hydrocarbon resins may be used.

The hydrocarbon resins mentioned above may be sourced from suppliers such as Exxon, Aksa Noble, Mitsui.

In addition, it is also desirable that the hydrocarbon resin has a high glass transition temperature, i.e. glass transition is the temperature at which the monomer starts to form a film. This reduces failure of dimensional stability of the resulting thermo-coating under load.

The hydrocarbon resin is provided in about 10 to 50% (w/w), but more preferably less than or equal to 20% (w/w). The proportions of the preferred thermo-coating are therefore about 80% (w/w) amorphous poly-α-olefin to about 20% (w/w) hydrocarbon resin. These proportions are not essential. However, a thermo-coating with these proportions is more likely to provide a layer substantially impervious to aqueous liquids while maintaining structural stability and providing sufficient grab.

A variety of optional components may be used to prepare the preferred thermo-coating.

For example, these may include an ignition resistant component, an anti-oxidant component and inorganic/organic extenders.

It will be appreciated that other additional components including colourings could be incorporated into the thermo-coating.

Ignition resisting components can be provided to improve the fire retardant property of the thermo-coating. In New Zealand, Occupational Safety and Health (OSH) requirements now require flame retardant properties and these can be addressed by the addition of ignition resisting components to the thermo-coating.

In a preferred embodiment, the ignition resistant component may be selected from ammonium phosphate, decabromodiphenyl oxide or alumina trihydrate. Tables 6, 7 and 8 below provide general properties of ammonium phosphate, decabromodiphenyl oxide and alumina trihydrate.

TABLE 6
Ammonium Phosphate

| Property | Unit | Typical Value |
|---|---|---|
| Phosphorous | % weight | 21 ± 1 |
| Nitrogen | % weight | 12.5 ± 1 |
| Specific Gravity | g/cm³ | 1.8 (approx) |
| Bulk Density | g/cm³ | 0.4 (approx) |
| Decomposition Temperature | ° C. | >250 |

TABLE 7
Decabromodiphenyl Oxide

| Property | Unit | Typical Value |
|---|---|---|
| Bromine (Theoretical) | % w/w | 83.3 |
| Specific Gravity | g/cm³ | 3.25 |
| Bulk Density | kg/m | 1,445 |
| Decomposition Temperature | ° C. | >304 |

TABLE 8
Alumina Trihydrate

| Chemical Composition (%) | Unit | Typical Value |
|---|---|---|
| Al(OH)₃ | | >98 |
| Na₂O (total) * | | 0.19-0.30 |
| Na₂O (soluble) * | | 0.01-0.10 |
| Fe₂O₃ * | | 0.004-0.012 |
| Property | | Typical Value |
| Refractive Index | | 1.57 |
| Density (g/cm³) | g/cm³ | 2.42 |
| Mohs Hardness | | 2.2-3.5 |
| Appearance | | White powder |
| Brightness | (% Z) | >99 |
| Medium Particle Size | (μ) | 0.8-1.4 |
| Surface Area | (m²/g) | 4.0-6.0 |

* The alumina trihydrate sourced contains additional trace species.

In the preferred embodiment, the thermo-coating includes about 1 to 10% (w/w) of the ignition resistant component, depending on the end use of the product. Of course more or less of the ignition retardant component may be used depending on a particular application of the thermo-coating.

The particular selection of ammonium phosphate, decabromodiphenyl oxide or alumina trihydrate as the ignition resistant components is in principle based on manufacture. Ammonium phosphate, decabromodiphenyl oxide or alumina trihydrate are highly compatible with the other constituents of the thermo-coating and can be readily dispersed throughout the thermo-coating.

As mentioned, the thermo-coating may also include an optional anti-oxidant component. The anti-oxidant component is present principally to maintain the quality of the polyolefin and hydrocarbon resin during manufacture. The anti-oxidant component prevents oxidation or charring of the polyolefin and hydrocarbon resin when held under prolonged heat during thermo-coating application to a surface (surface material, substrate etc).

In the preferred embodiment, the anti-oxidant is pentaerythritol. Pentaerythritol is highly compatible with the other ingredients used in the manufacture of the thermo-polyolefin compound. This means that it is dispensed throughout the thermo-coating. Table 9 provides the property information for pentaerythritol.

TABLE 9
Pentaerythritol

| Property | Unit | Typical Value |
|---|---|---|
| Melting Range | ° C. | 110-125 |
| Flash Point | ° C. | 297 |
| Specific Gravity at 20° C. | g/cm³ | 1.15 |
| Bulk Density (Powder) | g/l | 530-630 |
| Solubility at 20° C. | G | g/100 g solution |

Pentaerythritol is the most preferred antioxidant in manufacturing a thermo-coating of the present invention.

The inorganic/organic extender enables a more cost-effective product to be made for the modular tile market. In the preferred embodiment the inorganic/organic extender may include surface-coated calcium carbonate or magnesium oxide. Other inorganic/organic extenders will be known by those skilled in the art. Preferably calcium carbonate and magnesium oxide have a particle size no greater than 1.5 microns. Calcium carbonate and magnesium oxide will also improve impact resistance under load which is particularly important for modular tiles. A particle size of 1.5 microns is desirable to improve dispersion throughout the coating. Particles of greater size may cause lumps or grittiness in the resulting coating.

Modular tiles are smaller and require greater load resistance than, for example, a roll of surface coating, to sit stably on a substrate. To improve impact resistance, greater levels of inorganic/organic extender may be provided in the thermo-coating. Thus inorganic/organic extenders can be varied in the thermo-coating to improve impact resistance.

In a preferred embodiment the thermo-coating is formed from:
50 to less than 100% (w/w) of amorphous poly-α-olefin;
to equal to or less than 50% (w/w) of the hydrocarbon resin;
less than or equal to 50% (w/w) of an inorganic/organic extender;
1 to 10% (w/w) of the ignition resistant component; and
0.1 to 0.5% (w/w) of the anti-oxidant component.

In a more preferred embodiment, the thermo-coating is formed from:
equal to or less than 80% (w/w) of amorphous poly-α-olefin;
equal to or less than about 20% (w/w) of aliphatic hydrocarbon resin;
equal to or less than 50% (w/w) of an inorganic/organic extender;
8% (w/w) of ammonium phosphate; and
0.2% (w/w) of pentaerythritol.

The preferred thermo-coating is capable of providing a softening point of at least 124° C.±6° C. At this softening point, the thermo-coating has been found to give the optimum characteristics under load for dimensional stability.

The thermo-coating may be provided in a variety of forms depending on the particular application required.

In one preferred embodiment the thermo-coating may be provided as a layer, which is substantially impervious to aqueous liquids and is bound beneath a surface material (such as a carpet material, see Example 1), to form a surface coating. In this form the invention provides a surface coating substantially impervious to aqueous liquids and including the surface material and the thermo-coating include the polyolefin and hydrocarbon resin. The surface material can be a standard carpet or any other form of floor or wall covering.

The surface material may include multiple layers of common fabrics used in the carpet industry. In Example 2, the surface material includes a layer of conventional carpet and a layer of fibreglass.

The resulting surface coating incorporating the thermo-coating may provide any carpet, flooring, tile, panel, rug, mat or the like flooring or wall coating. The thermo-coating of the present invention has particular application in the flooring industry, where it is desirable to provide carpets and the like which are substantially impervious to aqueous liquids.

The surface coating appears as a “contiguous” layer of the surface material (which may itself be composed of multiple layers) and the thermo-coating. Effectively the surface material and thermo-coating are distinct and separate layers but bound together across a face.

The precise boundary between the thermo-coating and the surface material of the surface coating can appear “fuzzy”. The thermo-coating is partially absorbed into the surface material providing strong grab with the surface material. This reduces the likelihood of the thermo-coating separating from the surface material in use.

Where the surface material is carpet, the thermo-coating may be used not only to improve aqueous liquid impervious properties, but also to act as a binder within the carpet to lock fibres in place.

The thermo-coating is a direct replacement for aqueous materials currently used in the carpet industry for this purpose, including the following: styrene butadiene copolymers, acrylics, EVA, PVC and bitumen.

As mentioned, the thermo-coating preferably has a softening temperature of about 124° C.±6° C. This softening temperature is desirable as it means that a composition used to form the thermo-coating may be easily heated to 124° C. to be evenly and consistently spread across the back of the surface material and allowed to cool, so as to bind natural or synthetic fibres of the substrate, overcoming many of the disadvantages associated with other aqueous binding materials mentioned.

In an alternative form, the thermo-coating may be provided separate to a surface material as a tape panel, tile, laminate, roll or the like which is directly applied to the substrate before laying a final layer of surface material (i.e. carpet) onto the thermo-coating.

In this form the tape may be placed on the substrate and softened using a heated element, to melt and form a consistent layer across the substrate. The final layer, which may be carpet, may then be laid over and across the top of the thermo-coating. In this form, the thermo-coating may be underneath conventional carpets and other surface coatings.

Where the thermo-coating is to be used to prepare a surface coating integrating the surface material and thermo-coating described above, the invention also provides a method of manufacturing a surface coating substantially impervious to aqueous liquids including the step of applying a composition including a polyolefin and hydrocarbon resin, to the undersurface of the surface material to form the surface coating. The composition forms the thermo-coating on application to the surface material.

In a preferred method, the hydrocarbon resin and polyolefin are mixed and then heated between a temperature range of 190° C.±about 10° C. until a homogeneous thermo-coating mixture is formed, normally after 12 hours±about 1 hour and then allowed to cool to a range of 130° C.±about 10° C. before application. On cooling, the composition of the hydrocarbon resin and polyolefin can be applied to a surface material. Alternatively the composition can be poured into moulds for shaping into tape, tiles, panels, sections for rolls, etc for sale (separate to a surface material).

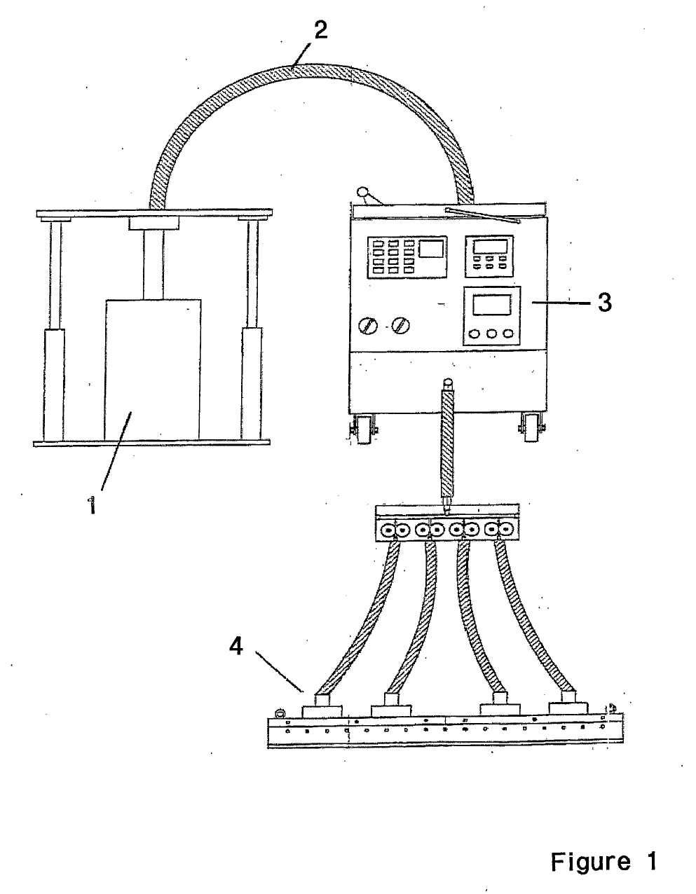

FIG. 1 illustrates apparatus which may be used to apply the thermo-coating to the surface material to form the surface coating.

Initially, the hydrocarbon resin and polyolefin are loaded in solid forms into a kettle 1. The kettle 1 is ideally insulated with a heated jacket to ensure consistent heating throughout the kettle 1. The temperature is raised in the kettle 1 to about 190° C.±about 10° C. and the materials are left for about 12 hours and until the hydrocarbon resin and polyolefin are in liquid form.

Once the polyolefin and hydrocarbon resin are in a liquid form, the composition formed may be stirred to a homogeneous consistency. At this stage other ingredients such as the ignition-resisting components, the anti-oxidant component and/or inorganic/organic extender may be added as desired. The temperature of the kettle 1 is then reduced to 130° C. for dispensing. Typically the composition has the following levels of compounds added to it:
50 to less than 100% (w/w) of amorphous poly-α-olefin;
to 50% (w/w) of the hydrocarbon resin;
1 to 50% (w/w) of an inorganic/organic extender;
1 to 10% (w/w) of the ignition resistant component; and
0.1 to 0.5% (w/w) of the anti-oxidant component.

The composition of the preferred embodiment may then be transferred to a different site for extrusion. This may be done by a pipe line 2 or by expelling the composition from the kettle 1 into a tank, drum or pellets for transfer.

The composition including about 80% (w/w) polyolefin to 20% (w/w) of hydrocarbon resin has good viscosity when heated to about 140° C. which assists in application of the coating to a surface material, a substrate or an extrusion bench. The temperature ratings and thixotropic properties are also ideal when in these proportions, as this gives the best flow characteristics to enable even layering of the product, along with optimum grab onto the substrate, and also gives the optimum softening point.

A transfer station 3 is adapted to control release of the composition in the preferred embodiment. In FIG. 1 the transfer station 3 is coupled to an application head 4 which is adapted to extrude the composition evenly across the reverse side of the surface material such as carpet. The level of composition extruded will depend on the requirements for a particular surface coating prepared. The application head 4 can be modified as desirable to control release of the composition.

Thus the invention also provides a surface coating prepared by the method described.

In the preferred form, the surface coating is provided as a contiguous layer of the thermo-coating and the surface material. This is desirable where the substrate material is new carpet directly from a loom for example.

Alternatively, the application head and the composition may be applied to an extrusion bench adapted to mould the composition into the appropriate form such as tape, tiles, panels etc as required at a temperature of 120° C. to 190° C. In this form, the resulting thermo-coating may be used in conjunction with current carpets and other surface coatings. The thermo-coating may then be rolled up for sale commercially or stacked into panels.

As covered above, the thermo-coating does away with the need for aqueous binders currently used in the carpet industry. The thermo-coating not only can be used to provide a layer substantially impervious to aqueous liquids beneath a substrate, such as carpet, but also binds the fibres of the carpet in place.

The thermo-coating, designed for the carpet industry, can be used as a direct replacement for any of the aqueous products currently being applied. The advantages of the invention include:
the thermo-coating is recyclable;
the thermo-coating is non-toxic and non-allergenic;
the thermo-coating can contain no plasticizers or other migrating compounds;
the thermo-coating is waterproof and water-resistant;
the thermo-coating is not affected by steam cleaning or contact with body fluids;
the thermo-coating can be formulated to meet ignition resistance requirements;
the thermo-coating is environmentally safe;
the thermo-coating requires no special handling for transport;
the thermo-coating has an excellent storage life;
in solid form, the characteristics of the thermo-coating alter little over time.

In a further alternative, the thermo-coating can be applied by a spray technique to a substrate before placement laying of conventional carpet. Methods of spraying the thermo-coating onto the substrate will be known in the art.

The invention also provides a kit of parts for manufacturing a composition which in use provides the thermo-coating including a polyolefin and a hydrocarbon resin.

The invention will now be described with reference to the Examples below.

### EXAMPLE 1

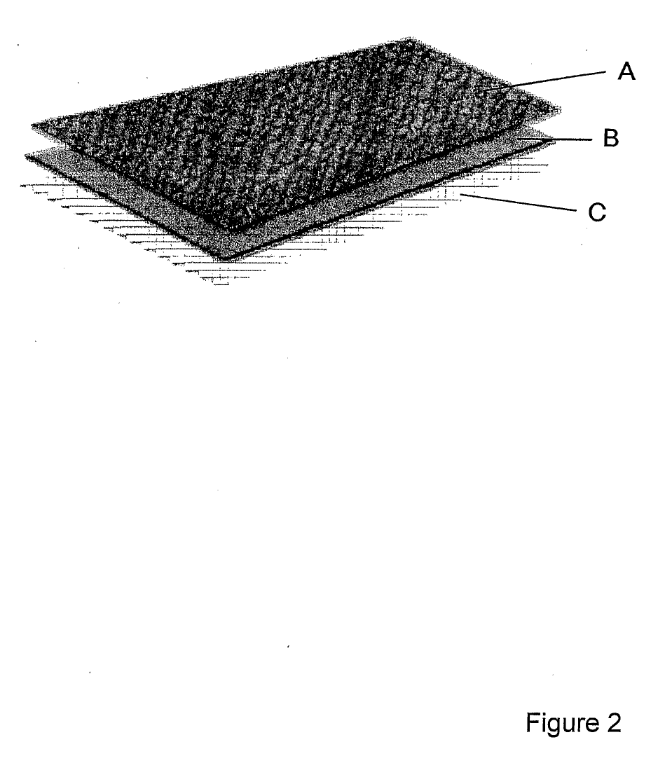

The thermo-coating of the preferred embodiment performs well in broadloom carpet compositions by operating on a one-pass system, with a single layer of the thermo-coating being applied. This application will lock the tuft and the tuft fibre, as well as a scrim underlayer (see exploded view in FIG. 2).

The application temperature for thermo-coating to all broadloom carpets (surface material) to form the surface coating is between 123° C. and 180° C. Application temperatures will vary within this range, dependent upon the fibre structure of the carpet (ie man-made or natural material).

### EXAMPLE 2

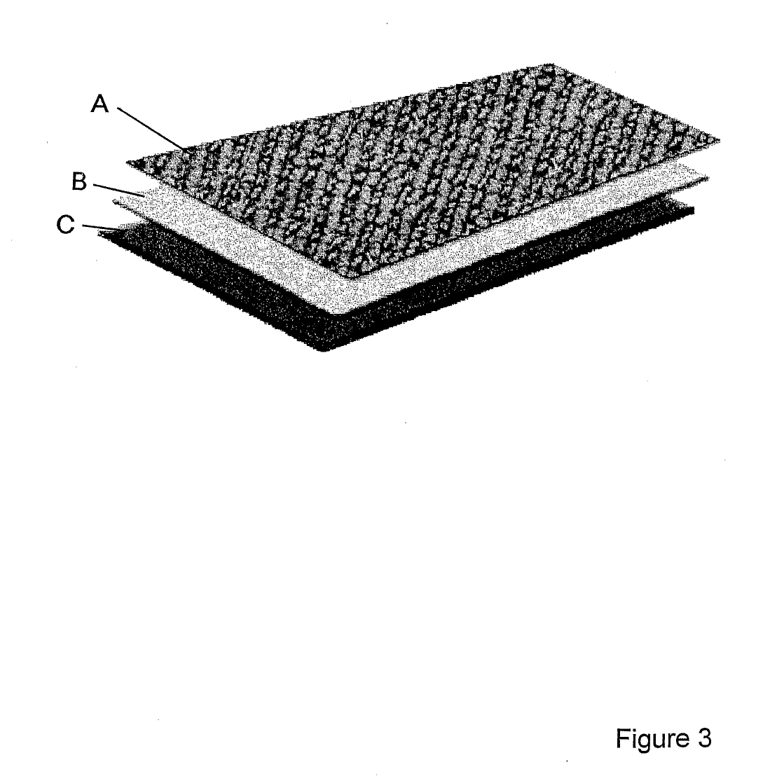

FIG. 3 illustrates an exploded view of a modular carpet (surface coating) including a surface material including multiple layers of conventional carpet and fibreglass bound to the thermo-coating of the preferred embodiment.

The application temperature for the thermo-coating to all modular carpet (surface material) is between 123° C. and 180° C. Application temperatures will vary within this range, dependent upon the fibre structure of the carpet (ie man-made or natural material).

A layer of fibreglass was added to the finished product for dimensional stability.

### EXAMPLE 3

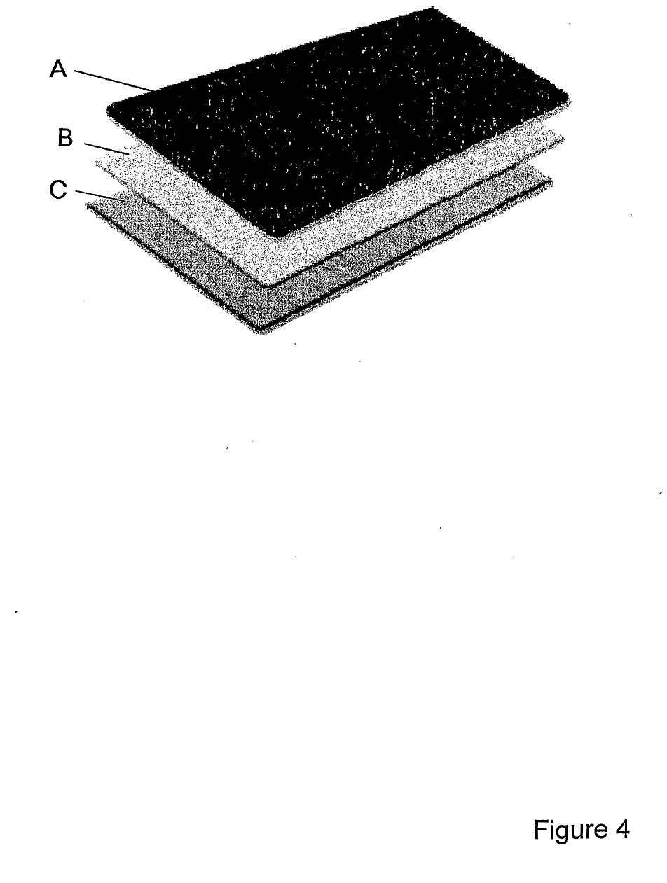

FIG. 4 illustrates an exploded view of a broadloom sports turf, incorporating the thermo-coating.

In modular tile construction, a layer of fibreglass is provided by the surface material to improve the finished product's dimensional stability of the resulting surface coating.

The application temperature of the thermo-coating to all types of synthetic sports turf is between 123° C. and 195° C. Application temperatures will vary within this range, dependent upon the composition of the material used in the product's construction.

Although the invention has been described by way of example and with reference to possible embodiments thereof, it will be appreciated that modification and improvements may be made to the invention without departing from the scope, methodology or ideology of the invention.

Wherein the foregoing description, reference has been made to specific components or integers with known equivalents, then such equivalents are herein incorporated as if individually set forth.

1. A thermo-coating, comprising:
a polyolefin; and
a hydrocarbon resin.

2. The thermo-coating according to claim 1, wherein the thermo-coating is substantially impervious to aqueous liquids.

3. The thermo-coating according to claim 1, wherein the thermo-coating is provided as a contiguous layer with a surface material.

4. The thermo-coating according to claim 1, wherein the polyolefin comprises an amorphous polyolefin of low molecular weight with a high softening point.

5. The thermo-coating according to claim 4, wherein the amorphous polyolefin of low molecular weight is a poly-α-olefin.

6. The thermo-coating according to claim 1, wherein the hydrocarbon resin is selected from cycloaliphatic hydrocarbon resins, polyterpene resins, AMS phenolic resins and toloil resin.

7. A thermo-coating according claim 1, wherein the thermo-coating comprises:
an amorphous poly-α-olefin;
a hydrocarbon resin;
an ignition resistant component; and
an anti-oxidant component.

8. The thermo-coating according to claim 7, wherein the thermo-coating comprises an inorganic/organic extender.

9. The thermo-coating according to claim 7, wherein the ignition resistant component is selected from ammonium phosphate, decabromodiphenyl oxide and alumina trihydrate.

10. The thermo-coating according to claim 7, wherein the anti-oxidant component is pentaerythritol.

11. The thermo-coating according to claim 1, wherein the thermo-coating comprises:
50 to less than 100% (w/w) of amorphous poly-α-olefin;
10 to 50% (w/w) of hydrocarbon resin;
1 to 50% (w/w) of an inorganic/organic extender;
1 to 10% (w/w) of ignition resistant component; and
0.1 to 0.5% (w/w) of anti-oxidant component.

12. The thermo-coating according to claim 1, wherein the thermo-coating comprises:
less than or equal to 80% (w/w) of amorphous poly-α-olefin;
less than or equal to 20% (w/w) of cycloaliphatic hydrocarbon resin;
less than or equal to 50% (w/w) of an inorganic/organic extender;
8% (w/w) of ammonium phosphate; and
0.2% (w/w) of pentaerythritol.

13. The thermo-coating according to claim 4, wherein the thermo-coating has a softening point of at least 124° C.+/−6° C.

14. The thermo-coating according to claim 3, wherein the surface material comprises a standard carpet or any other form of floor covering.

15. The thermo-coating according to claim 1, wherein the thermo-coating is provided as a tape, panel, tile, or layer laminate.

16. A surface coating, comprising a surface material and a thermo-coating formed from:
a polyolefin; and
a hydrocarbon resin
wherein the thermo-coating provides a layer substantially impervious to aqueous liquids.

17. The surface coating according to claim 16, wherein the polyolefin comprises an amorphous polyolefin of low molecular weight with a high softening point.

18. The surface coating according to claim 17, wherein the amorphous polyolefin of low molecular weight is a poly-α-olefin.

19. The surface coating according to claim 16, wherein the hydrocarbon resin is selected from cycloaliphatic hydrocarbon resins, polyterpene resins, AMS phenolic resins and toloil resin.

20. The surface coating according to claim 16, wherein the surface coating comprises:
an amorphous poly-α-olefin;
a hydrocarbon resin;
an ignition resistant component; and
an anti-oxidant component.

21. The surface coating according to claim 16, wherein the thermo-coating comprises an inorganic/organic extender.

22. The surface coating according to claim 20, wherein the ignition resistant component is selected from ammonium phosphate, decabromodiphenyl oxide and alumina trihydrate.

23. The surface coating according to claim 20, wherein the anti-oxidant component is pentaerythritol.

24. The surface coating according to claim 20, wherein the thermo-coating comprises:
50 to less than 100% (w/w) of amorphous poly-α-olefin;
10 to 50% (w/w) of hydrocarbon resin;
1 to 50% (w/w) of an inorganic/organic extender;
1 to 10% (w/w) of ignition resistant component; and
0.1 to 0.5% (w/w) of anti-oxidant component.

25. The surface coating according to claim 24, wherein the thermo-coating comprises:
less than or equal to 80% (w/w) of amorphous poly-α-olefin;
less than or equal to 20% (w/w) of cycloaliphatic hydrocarbon resin;
less than or equal to 50% (w/w) of an inorganic/organic extender;
8% (w/w) of ammonium phosphate; and
0.2% (w/w) of pentaerythritol.

26. The surface coating according to claim 16, wherein the thermo-coating is provided as a tape, panel, tile, layer, or laminate.

27. The surface coating according to claim 16, wherein the thermo-coating is provided as a contiguous layer with the surface material.

28. The surface coating according to claim 16, wherein the surface material comprises carpet or any other form of floor covering.

29. A composition for preparing a thermo-coating, comprising: a polyolefin; and a hydrocarbon resin.

30. The composition according to claim 29, wherein the polyolefin comprises an amorphous polyolefin of low molecular weight with a high softening point.

31. The composition according to claim 30, wherein the amorphous polyolefin of low molecular weight is a poly-α-olefin.

32. The composition according to claim 29, wherein the hydrocarbon resin is selected from cycloaliphatic hydrocarbon resins, polyterpene resins, AMS phenolic resins and toloil resin.

33. The composition according to claim 29, wherein the composition includes comprises:
an amorphous poly-α-olefin;
a hydrocarbon resin;
an ignition resistant component; and
an anti-oxidant component.

34. The composition according to claim 33, wherein the composition comprises an inorganic/organic extender.

35. The composition according to claim 33, wherein the ignition resistant component is selected from ammonium phosphate, decabromodiphenyl oxide and alumina trihydrate.

36. The composition according to claim 33, wherein the anti-oxidant component is pentaerythritol.

37. The composition according to claim 33, wherein the composition comprises:
50 to less than 100% (w/w) of amorphous poly-α-olefin;
10 to 50% (w/w) of hydrocarbon resin;
1 to 50% (w/w) of an inorganic/organic extender;
1 to 10% (w/w) of ignition resistant component; and
0.1 to 0.5% (w/w) of anti-oxidant component.

38. The composition according to claim 33, wherein the composition comprises:
less than or equal to 80% (w/w) of amorphous poly-α-olefin;
less than or equal to 20% (w/w) of cycloaliphatic hydrocarbon resin;
less than or equal to 50% (w/w) of an inorganic/organic extender;
8% (w/w) of ammonium phosphate; and
0.2% (w/w) of pentaerythritol.

39. The composition according to claim 33, wherein the composition is adapted to be applied directly to a substrate to form the thermo-coating.

40. A surface coating substantially impervious to aqueous liquids, comprising a surface material and a thermo-coating contiguous with a surface material, the thermo-coating formed from a composition including a polyolefin and a hydrocarbon resin.

41. The surface coating according to claim 40, wherein the surface material comprises carpet.

42. The surface coating according to claim 40, wherein the polyolefin comprises an amorphous poly-α-olefin of low molecular weight with a high softening point.

43. The composition according to claim 40, wherein the composition comprises:
an amorphous poly-α-olefin;
a hydrocarbon resin;
an ignition resistant component; and
an anti-oxidant component.

44. The composition according to claim 43, wherein the composition comprises an inorganic/organic extender.

45. The surface coating according to claim 43, wherein the ignition resistant component is selected from ammonium phosphate, decabromodiphenyl oxide and alumina trihydrate.

46. The composition according to claim 45, wherein the anti-oxidant component is pentaerythritol.

47. The composition according to claim 45, wherein the hydrocarbon resin is selected from cycloaliphatic hydrocarbon resins, polyterpene resins, AMS phenolic resins and toloil resin.

48. The composition according to claim 40, wherein the composition comprises:
50 to less than 100% (w/w) of amorphous poly-α-olefin;
10 to 50% (w/w) of hydrocarbon resin;
1 to 50% (w/w) of inorganic/organic extender;
1 to 10% (w/w) of ignition resistant component; and
0.1 to 0.5% (w/w) of anti-oxidant component.

49. The composition according to claim 48, wherein the composition comprises:
less than or equal to 80% (w/w) of amorphous poly-α-olefin;
less than or equal to 20% (w/w) of cycloaliphatic hydrocarbon resin;
less than 50% (w/w) of inorganic/organic extender;
8% (w/w) of ammonium phosphate; and
0.2% (w/w) of pentaerythritol.

50. A method of manufacturing a surface coating substantially impervious to aqueous liquids, including the step of applying a composition formed from a polyolefin and a hydrocarbon resin to a surface material to form the surface coating, the composition forming an aqueous liquid impervious thermo-coating following mixing the polyolefin and hydrocarbon resin, heating the mixture and applying the heated mixture to the surface material.

51. The method according to claim 50, wherein the composition is applied to the surface material to form a contiguous layer with the surface material.

52. The method according to claim 50, wherein the surface material comprises carpet or any other form of floor covering.

53. A kit of parts for manufacturing the composition which in of claim 29, the kit of parts including: a polyolefin; and a hydrocarbon resin.

54-58. (canceled)

59. A kit of parts for manufacturing the composition of claim 40, the kit of parts including: a polyolefin; and a hydrocarbon resin.

60. A kit of parts for manufacturing the composition of claim 50, the kit of parts including: a polyolefin; and a hydrocarbon resin.
